(19) United States
(12) Patent Application Publication
(10) Pub. No.: US 2024/0351124 A1
(43) Pub. Date: Oct. 24, 2024

(54) SOLDERING STATION WITH IRON HOLDER

(71) Applicant: Apex Brands, Inc., Apex, NC (US)

(72) Inventors: Steve Batsa, Lexington, SC (US); John Fiumefreddo, Irmo, SC (US)

(21) Appl. No.: 18/574,865

(22) PCT Filed: Jul. 19, 2022
(86) PCT No.: PCT/US2022/037566

§ 371 Date: Dec. 28, 2023

Related U.S. Application Data
(60) Provisional application No. 63/224,156, filed on Jul. 21, 2021.

(51) Int. Cl. B23K 3/02; B23K 3/03; B23K 3/08

(52) U.S. Cl. CPC B23K 3/027; B23K 3/0346; B23K 3/085

(57) ABSTRACT

A soldering station or a soldering station system including a soldering station and a soldering iron includes a control console and an iron holder operably coupled to the control console for supporting a soldering iron. The iron holder comprises a handle support portion and a base portion operably coupling the handle support portion to the control console. The handle support portion is oriented with respect to the base portion to define an axis. The axis forms an angle of between about 10 degrees to about 40 degrees relative to a horizontal surface supporting the soldering station. The handle support portion is shaped to receive the soldering iron in a tip-up orientation. The soldering iron may include a handle, a transition portion, a shaft portion, a tip, and a longitudinal centerline.

### TECHNICAL FIELD

Example embodiments generally relate to soldering tools and, in particular, relate to such a soldering station having the ability to support a soldering iron.

### BACKGROUND

Soldering tools, which are sometimes referred to as soldering irons or soldering guns, are commonly used in electronics manufacturing and repair activities along with other crafts and industries that involve metalwork. Soldering tools are typically used to join metallic items together at a joint by melting a filler metal (i.e., solder) into the joint. The solder has a lower melting point than the items being joined together at the joint, so the soldering tool needs to apply heat sufficient to melt the solder, but not hot enough to melt the items being joined.

Although a number of soldering tool designs have been proposed, a basic soldering tool design includes at least a tip portion that is operably coupled to a heater. The tip portion may, due to operation of the heater, become hot enough to melt the solder that contacts the tip portion. The tip portion may, in some cases, be removable/interchangeable so that a number of different geometries (e.g., sizes and/or shapes) of tips or bits can be substituted for respective different jobs. For example, some tip geometries (or shapes) may include a fine conical tip, a tapered chisel tip, a pyramid tip, a triangular flat face tip, a wide flat face tip, etc., where different sizes may further be available within each respective shape category.

Soldering is often performed at a workstation, and may be performed in some cases using soldering irons that are attached to soldering stations and rest in soldering iron holders when not in use. Some soldering iron stations have iron holders built into them. Typically, iron holders are configured to orient the soldering iron in such a way so that the handle is higher up than the tip, so that the operator may more easily grab the handle to use the soldering iron again. However, with the amount of heat soldering irons operate with, the handle of a soldering iron may tend to get hot through natural laws of heat transfer while the soldering iron is resting in a position where the handle is above the tip. Thus, having a safe iron holder to rest the soldering iron on when it is not in use is crucial to ensuring that the high heat of the soldering iron tip does not reach other components of the soldering iron, the surrounding workstation, and/or the operator. Thus, it may be desirable to provide an improved soldering iron station and iron holder that can, for example, hold the soldering iron in a position where the tip is above the handle in a manner that is easier for an operator to interact with and safer for the operator and the surrounding workstation.

### BRIEF SUMMARY OF SOME EXAMPLES

Some example embodiments may enable the provision of a soldering station that may hold a soldering iron in a more effective resting position.

In an example embodiment, a soldering station may be provided. The soldering station may include a control console, an iron holder which may be operably coupled to the control console for supporting a soldering iron, the iron holder may comprise a handle support portion and a base portion which may operably couple the handle support portion to the control console. The handle support portion may be oriented with respect to the base portion and may define an axis. The axis may form an angle of between about 10 degrees to about 40 degrees relative to a horizontal surface which may support the soldering station. The handle support portion may be shaped to receive the soldering iron in a tip-up orientation.

In another example embodiment, a soldering station system including a soldering station and a soldering iron may be provided. The system may include a control console, an iron holder which may be operably coupled to the control console for supporting a soldering iron, the iron holder may comprise a handle support portion and a base portion which may operably couple the handle support portion to the control console. The handle support portion may be oriented with respect to the base portion and may define an axis. The axis may form an angle of between about 10 degrees to about 40 degrees relative to a horizontal surface which may support the soldering station. The handle support portion may be shaped to receive the soldering iron in a tip-up orientation. The soldering iron may include a handle, a transition portion, a shaft portion, a tip, and a longitudinal centerline.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1A illustrates a perspective view of a soldering station with iron holder according to an example embodiment;

FIG. 1B illustrates a perspective view of the soldering station of FIG. 1A holding a soldering iron according to an example embodiment;

FIG. 2A illustrates a side view of the soldering station of FIG. 1A in accordance with an example embodiment;

FIG. 2B illustrates a side view of the soldering station of FIG. 1A holding a soldering iron in accordance with an example embodiment;

FIG. 3A illustrates a top view of the soldering station of FIG. 1A according to an example embodiment;

FIG. 3B illustrates a top view of the soldering station of FIG. 1A holding a soldering iron in accordance with an example embodiment;

FIG. 4A illustrates a front view of the soldering station of FIG. 1A in accordance with an example embodiment;

FIG. 4B illustrates a front view of the soldering station of FIG. 1A holding a soldering iron in accordance with an example embodiment; and

FIG. 5 illustrates a rear view of the soldering station of FIG. 1A holding a soldering iron in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of a soldering station with iron holder that includes features that make it safer to store a soldering iron with a hot tip. In some cases, a heat shield may be employed to assist in this regard. However, other strategies and features are also contemplated as described in greater detail below.

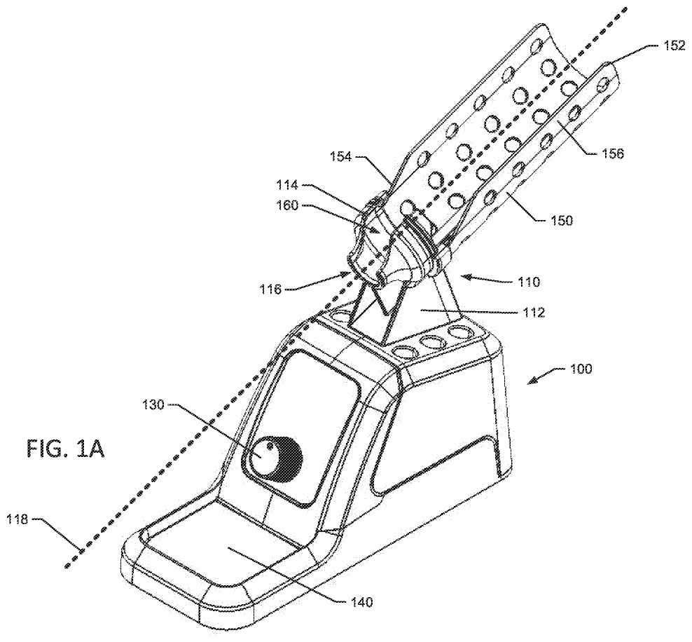

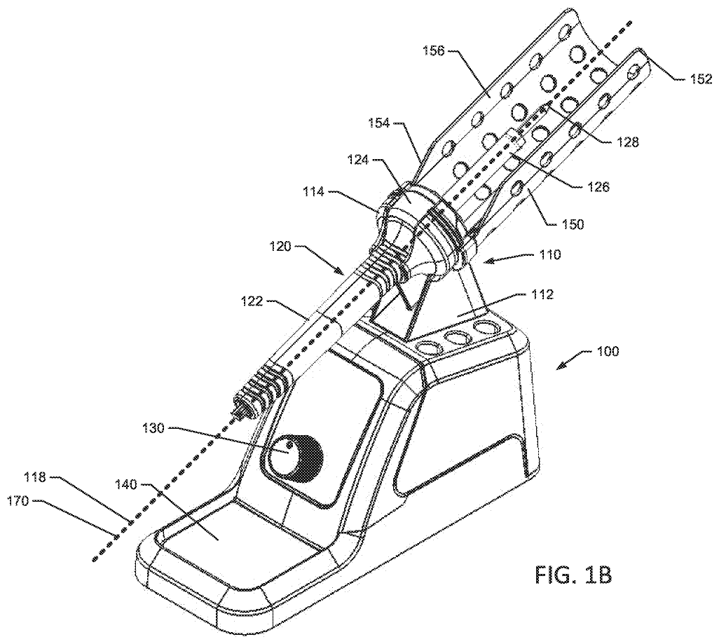

FIG. 1A illustrates a perspective view of a soldering station 100 with an iron holder 110 according to an example embodiment. Additionally, FIG. 1B illustrates a perspective view of the soldering station 100 of FIG. 1A holding a soldering iron 120 according to an example embodiment. In some embodiments, the soldering iron 120 may include a handle 122, a transition portion 124, a shaft portion 126, and a tip 128. As shown in FIGS. 1A and 1B, the soldering station 100 of an example embodiment may further include a control console that includes any or all of a power source (e.g. mains power) (not shown), heat control 130, and an accessory holding portion 140. As shown in FIG. 1B, the iron holder 110 may be configured to hold the soldering iron 120 in a resting position when the soldering iron 120 is not in use. In some embodiments, the iron holder 110 may be disposed at the top of the soldering station 100, and may provide ease of access for an operator to interact with the soldering iron 120. The iron holder 110 may further include a base portion 112, a handle support portion 114, and a heat shield 150. The base portion 112 may operably couple the handle support portion 114 to the soldering station 100. In some embodiments, the handle support portion 114 may include an opening 116, and an axis 118 that may pass through a center of the opening 116. In some cases, the opening 116 may be substantially circular. In some example embodiments, the axis 118 may be normal to the opening 116. The opening 116, and therefore the axis 118, may form an angle less than 90 degrees relative to a horizontal plane passing through the accessory holding portion 140. The handle support portion 114 may be configured to hold the handle 122 of the soldering iron 120 such that the soldering iron 120 may be secured in a tip-up orientation.

In some embodiments, the soldering iron 120 may be connected to the soldering station 100 via a cable (not shown) at an end of the handle 122 opposite from the transition portion 124. The transition portion 124 may be where the handle 122 meets the shaft portion 126. The shaft portion 126 may operably couple the tip 128 to the transition portion 124. In some embodiments, the soldering iron 120 may comprise a larger diameter at the transition portion 124 than at any of the handle 122, the shaft portion 126, or the tip 128. In some embodiments, the transition portion 124 may be configured to operably couple with the iron holder 110. In this regard, the transition portion 124 may assist in enabling the soldering iron 120 to be secured in a tip-up resting position by operably coupling with the handle support portion 114 of the iron holder 110. In some embodiments, the handle support portion 114 may be operably couple with the transition portion 124 of the soldering iron 120. As such, the soldering iron 120 may be secured into the tip-up resting position in the handle support portion 114 by inserting the soldering iron 120 slightly in front of the handle support portion 114, guiding the handle 122 through the opening 116 along axis 118, and seating the soldering iron 120 within the handle support portion 114. To accommodate the soldering iron 120, the handle support portion 114 may have a gap 160 on its top side (away from the base portion 112) that may be slightly wider than the width of the handle 122. Remaining portions of the handle support portion 114 may define a collar that is shaped to fit the transition portion 124. In this regard, the handle support portion 114 may be molded to complement the shape of the transition portion 124 so that the collar can only support the soldering iron 120 in one way. In particular, the one way is with the transition portion 124 supported above (e.g., at a higher elevation or farther away from the horizontal surface on which the soldering station 100 is supported) the handle 122. Furthermore, the tip 128 is supported at a higher elevation than the shaft portion 126, which is also at a higher elevation than the transition portion 124 and the handle 122. Thus, in some embodiments, the handle 122 may pass through the gap 160 and into the handle support portion 114 where it then may be set down through the opening 116. On the other hand, the transition portion 124 may only enter the handle support portion 114 responsive to being seated into place as mentioned above. In other words, the transition portion 124 of the soldering iron 120 may not fit in the gap 160. The handle support portion 114 may act as a single point of contact between the soldering iron 120 and the soldering station 100 to secure the soldering iron 120 in the tip-up resting position. Moreover, the opening 116 may be smaller (i.e., having a diameter sufficient to extend around the handle 122), whereas as the gap 160 moves away from the opening 116, the collar may extend in diameter to match the larger diameter of the transition portion 124.

In some embodiments, the handle support portion 114 of the iron holder 110 may be operably coupled to the base portion at an angle between 10 and 40 degrees relative to a horizontal surface that the soldering station 100 may be placed on. Additionally, the soldering iron 120, may include a longitudinal centerline 170 which may be coaxial with axis 118 of the handle support portion 114 when the soldering iron 120 is resting in the iron holder 110. In the tip-up resting position, the highest point of elevation on the soldering iron 120 may be the tip 128. In some embodiments, the elevation of the tip 128 may not exceed that of the heat shield 150 when the soldering iron 120 is resting in the iron holder 110. In some embodiments, in the tip-up resting position, the soldering iron 120 may be supported and/or contacted by a single point of contact with the iron holder 110.

The heat control 130 of the soldering station 100 may be utilized by an operator to set the desired temperature of the soldering iron 120. In some embodiments, the heat control 130 may be a dial which may be operably coupled to a variable resistor (i.e. potentiometer) (not shown). In this regard, the act of turning the dial is a direct act of changing the amount of resistance encountered by a current between its origin at the power source and its destination at the soldering iron 120. The shaft portion 126 of the soldering iron 120 may include a heater element (not shown) that may be or include a resistive element that generates heat responsive to the running of current therethrough. The heater element may be disposed at or near the shaft portion 126 to heat metal in the tip 128 as the temperature of the heater rises. The heated tip 128 may then be used to melt solder for creation of a solder joint. Thus, the heat control 130 of the soldering station 100 directly affects how hot the soldering iron 120 gets by controlling the power supply to the heater element of the shaft portion 126.

The accessory holding portion 140 may be configured to hold any accessory that may be useful for the successful operation of the soldering iron 120. For example, in some embodiments, the accessory holding portion 140 may be configured to hold a sponge that may help clean the tip 128 of the soldering iron 120 after each use. In some other embodiments, the accessory holding portion 140 may be configured to hold a brass sponge that may help clean the tip 128 of the soldering iron 120. In some embodiments, the accessory holding portion 140 may be disposed at a base of the soldering station 100 and may also extend out proximate the heat control 130. In some embodiments, the accessory holding portion 140 may be substantially planar and horizontal. In such cases, the accessory holding portion 140 may be substantially parallel to a horizontal surface that the soldering station 100 may be placed on.

The iron holder 110 may also include heat shield 150. The heat shield 150 may be configured to at least partially encircle the tip 128 of the soldering iron 120 when the soldering iron 120 is in a resting position in the handle support portion 114 of the iron holder 110. The heat shield 150 may prevent the operator or other objects from touching the tip 128 of the soldering iron 120. In some embodiments, the heat shield 150 may comprise a singular piece of metal that may be bent and cut into shape. In some embodiments, the heat shield 150 may be perforated with holes to allow for better circulation of air to the tip 128, and avoid focusing the heat radiated from the tip 128 at a location above the heat shield 150. In some embodiments, the heat shield 150 may be bent into a half-pipe shape to make it easier for an operator to insert and remove the soldering iron 120 into the iron holder 110. In some embodiments, the heat shield 150 may also include lateral sides 156 on the ends of the half-pipe shape. The lateral sides 156 may extend a distance above the axis 118 and the longitudinal centerline 170 in order to provide better coverage of the shaft portion 186 and the tip 188 of the soldering iron 180. Additionally, in some embodiments, the heat shield 150 may operably couple to the handle support portion 114 of the iron holder 110. Since the heat shield 150 may be operably coupled to the handle support portion 114 of the iron holder 110, there may not be any space between the heat shield 150 and the handle support portion 114. Therefore, in order to sufficiently extend beyond the tip 128, a length of the heat shield 150 along the axis 118 from the elevated end 152 to the lower end 154 may be greater than a length of the shaft portion 126 plus the tip 128 of the soldering iron 120, measured from the transition portion 124 to the distal end of the tip 128. In some cases, the heat shield 150 may be removably operably coupled to the handle support portion 114 via a mechanical locking mechanism (e.g. a clip). As such, the heat shield 150 may be able to be cleaned before and/or after using the soldering station 100 responsive to removing the heat shield 150 from the handle support portion 114.

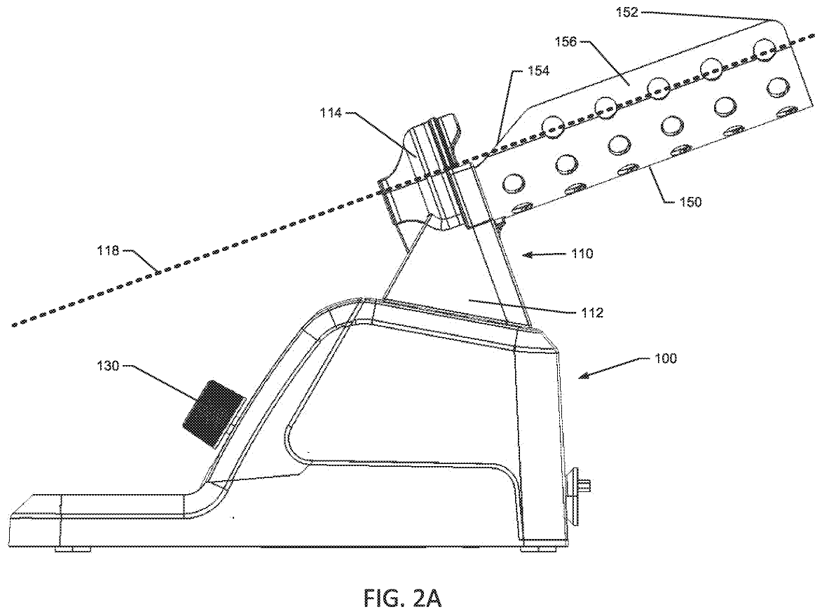

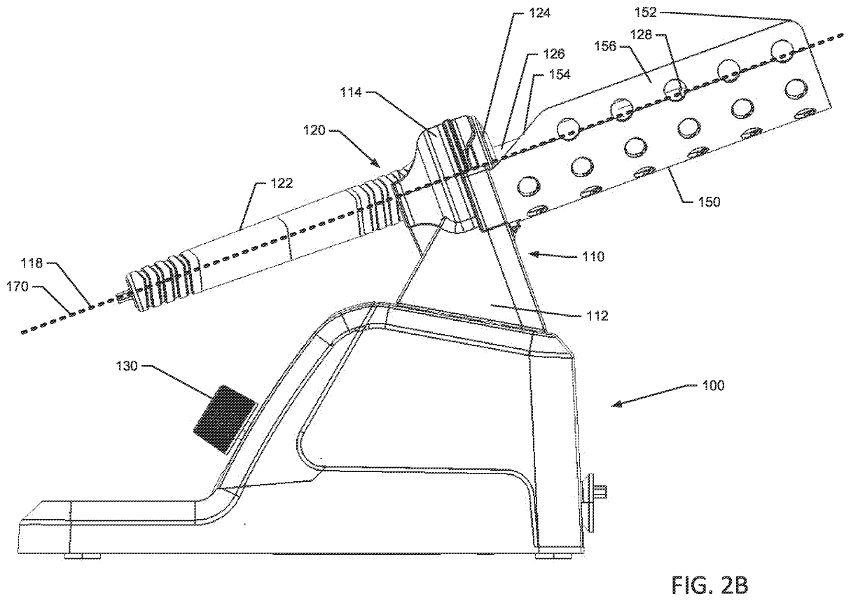

FIG. 2A illustrates a side view of a soldering station 100 with an iron holder 110 according to an example embodiment. Additionally, FIG. 2B illustrates a side view of the soldering station 100 of FIG. 1A holding a soldering iron 120 according to an example embodiment. FIGS. 2A and 2B better depict that the handle support portion 114 of the iron holder 110 may be operably coupled to the base portion at an angle between 10 and 40 degrees relative to a horizontal surface that the soldering station 100 may be placed on. Since in some cases the longitudinal centerline 170 of the soldering iron 120 and the axis 118 of the handle support portion 114 may be coaxial while the soldering iron 120 is in the resting position, the angle of the soldering iron 120 may be between 10 and 40 degrees to a horizontal surface that the soldering station 100 may be placed on in the tip-up resting position. In this regard, the heat shield 150 may have an elevated end 152 that is disposed at a greater distance from the control console than a lower end 154 of the heat shield 150. The lower end 154 may be disposed at a lesser distance from the control console than the elevated end 152. In some embodiments, the elevated end 152 may be the point of maximum elevation of the entire soldering station 100. The tip 128 of the soldering iron 120 may be disposed roughly halfway up the heat shield when the soldering iron 120 is placed in the iron holder 110. The elevated end 152 of the heat shield 150 may extend beyond the tip 128 when the soldering iron 120 is in the resting position. In some example embodiments, the axis 118 may be normal to the opening 116. The opening 116, and therefore the axis 118, may form an angle less than 90 degrees (e.g. between 10 and 40 degrees) relative to a horizontal surface that the soldering station 100 may be placed on.

As a result of the soldering iron 120 being in the tip-up resting position, the handle 122 may not get hot while the soldering iron is not in use. In an orientation where the tip 128 may be the highest point of elevation of the soldering iron 120, heat from the tip 128 may be better transferred to the air surrounding the tip 128 as well as the heat shield 150. Thus, in this tip-up orientation, the handle 122 may be better insulated due to the natural laws of heat transfer. Additionally, the handle 122 may also be insulated in part from the handle support portion 114. In this regard, when an operator attempts to grab hold of the handle 122 to use the hot soldering iron 120, the handle 122 may be less hot.

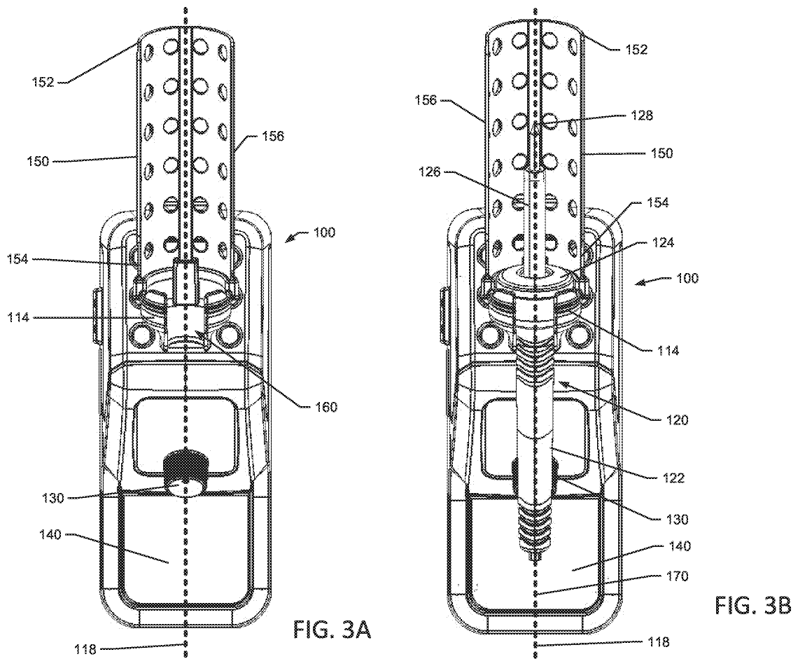

FIG. 3A illustrates a top view of a soldering station 100 with an iron holder 110 according to an example embodiment. Additionally, FIG. 3B illustrates a top view of the soldering station 100 of FIG. 1A holding a soldering iron 120 according to an example embodiment. FIG. 3B also shows an alternative view to longitudinal centerline 170. This view may clarify that the longitudinal centerline 170 of the soldering iron 120, may be coaxial with the axis 118 of the heat shield 150, and the iron holder 110. In some embodiments, the heat shield 150 extends beyond the tip 128 of the soldering iron 120. In some embodiments, and as mentioned previously, the transition portion 124 may interact with the handle support portion 114 and hold the soldering iron 120 in the tip-up resting position (defined by the 10-40 degree up-angle at which the soldering iron 120 is necessarily supported by the shape of the collar that is formed to support the soldering iron 120).

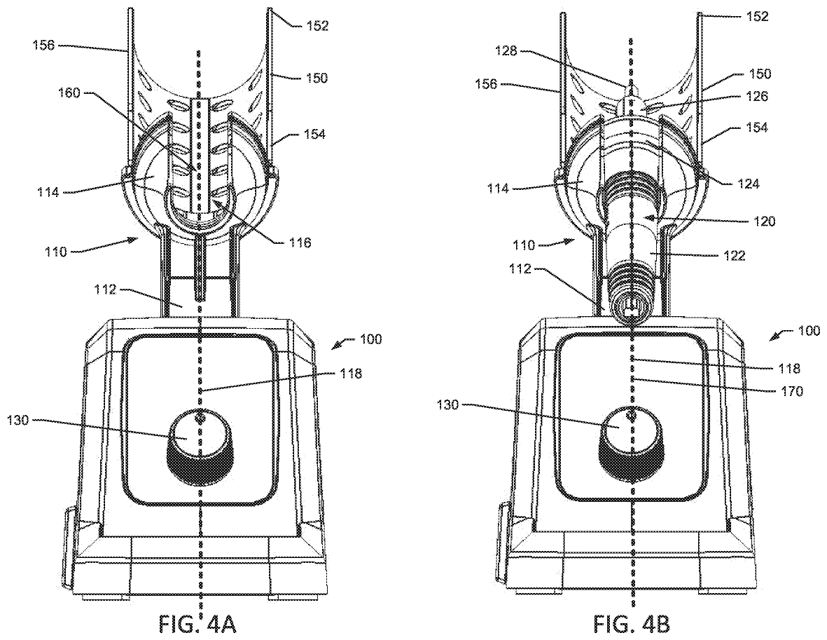

FIG. 4A illustrates a front view of a soldering station 100 with an iron holder 110 according to an example embodiment. Additionally, FIG. 4B illustrates a front view of the soldering station 100 of FIG. 1A holding a soldering iron 120 according to an example embodiment. In some embodiments, the heat shield 150 may not extend below the handle support portion 114. In some other embodiments, the gap 160 may extend from the opening 116 of the handle support portion 114 to a distal end of the handle support portion 114. As shown in FIG. 4B, in some embodiments, the gap 160 may be wide enough to allow for the handle 122 to pass through. In some embodiments, the handle support portion 114 is the only part of the iron holder 110, and the soldering station 100, to contact the soldering iron 120 when the soldering iron 120 is in a resting position. In FIG. 4B, the axis 118 and longitudinal centerline 170 are again shown in a different view, this time highlighting the relationship of the soldering iron 120, the heat shield 150, and the handle support portion 114 from the rear view. In some embodiments, and as mentioned previously, the transition portion 124 may operably couple with the handle support portion 114 and hold the soldering iron 120 in the tip-up resting position. In this regard, the handle 122 of the soldering iron 120 may not get hot while in between uses.

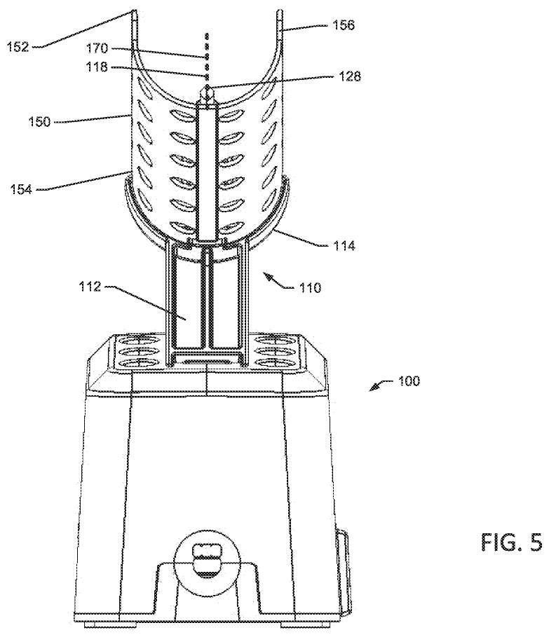

FIG. 5 illustrates a rear view of the soldering station 100 of FIG. 1A holding a soldering iron 120 in accordance with an example embodiment. In some embodiments, neither the shaft portion 126 nor the tip 128 may be in contact with the heat shield 150 when in the tip-up resting position. The heat shield 150 may be offset from the shaft portion 126 and the tip 128, but may also provide a level of protection from the tip 128.

Thus, according to an example embodiment, a soldering station or a system including a soldering station and a soldering iron may be provided. The soldering station or system may include a control console, an iron holder which may be operably coupled to the control console for supporting a soldering iron, the iron holder may comprise a handle support portion and a base portion which may operably couple the handle support portion to the control console. The handle support portion may be oriented with respect to the base portion and may define an axis. The axis may form an angle of between about 10 degrees to about 40 degrees relative to a horizontal surface which may support the soldering station. The handle support portion may be shaped to receive the soldering iron in a tip-up orientation. The soldering iron may include a handle, a transition portion, a shaft portion, a tip, and a longitudinal centerline.

In some cases, the soldering station described above may be augmented or modified by altering individual features mentioned above or adding optional features. The augmentations or modifications may be performed in any combination and in any order. For example, in some cases, the soldering iron may comprise a handle, a transition portion, a shaft portion, a tip, and a longitudinal centerline. In an example embodiment, the handle support portion may be shaped to correspond to a shape of the transition portion of the soldering iron. In some cases, the axis of the handle support portion and the longitudinal centerline of the soldering iron may be coaxial while the soldering iron is retained in the handle support portion. In an example embodiment, the handle support portion may be a sole point of contact between the iron holder and the soldering iron while the soldering iron is held by the iron holder. In some cases, the iron holder may further comprise a heat shield which may be operably coupled to the handle support portion. In an example embodiment, the heat shield may comprise an elevated end and a lower end, the elevated end may be disposed farther away from the handle support portion than the lower end. In some cases, the heat shield may comprise a metal plate formed into a half pipe. In an example embodiment, the heat shield may be disposed at an angle of 10 to 40 degrees relative to the horizontal surface supporting the soldering station. In some cases, the handle support portion may comprise a collar that defines a gap. In an example embodiment, the handle of the soldering iron may fit through the gap, but the transition portion may not fit through the gap such that the transition portion may be retained by the collar. In some cases, the metal plate may have lateral sides that may extend beyond the longitudinal centerline of the soldering iron when the soldering iron is disposed in the iron holder. In an example embodiment, a length of the heat shield measured from the elevated end to the lower end may exceed a length of the soldering iron measured from the transition portion to a distal end of the tip. In some cases, the heat shield may be perforated with holes. In an example embodiment, the heat shield may be removably connected to the iron holder. In some cases, the control console may comprise a power source, a heat control, and an accessory holding portion. In an example embodiment, the accessory holding portion may define a plane that may be parallel to, and spaced apart from the horizontal surface supporting the soldering station by a first distance. In some cases, the handle support portion may be spaced apart from the horizontal surface supporting the soldering station by a second distance. In an example embodiment, the heat shield may be spaced apart from the horizontal surface supporting the soldering station by a third distance. In some cases, the first distance may be less than the second distance, and the second distance may be less than the third distance.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A soldering station comprising:
a control console; and
an iron holder operably coupled to the control console for supporting a soldering iron, the iron holder comprising a handle support portion and a base portion operably coupling the handle support portion to the control console,
wherein the handle support portion is oriented with respect to the base portion to define an axis,
wherein the axis forms an angle of between about 10 degrees to about 40 degrees relative to a horizontal surface supporting the soldering station, and
wherein the handle support portion is shaped to receive the soldering iron in a tip-up orientation.

2. The soldering station of claim 1, wherein the soldering iron comprises a handle, a transition portion, a shaft portion, a tip, and a longitudinal centerline, and
wherein the handle support portion is shaped to correspond to a shape of the transition portion of the soldering iron.

3. The soldering station of claim 2, wherein the axis of the handle support portion and the longitudinal centerline of the soldering iron are coaxial while the soldering iron is retained in the handle support portion.

4. The soldering station of claim 2, wherein the handle support portion is a sole point of contact between the iron holder and the soldering iron while the soldering iron is held by the iron holder.

5. The soldering station of claim 3, wherein the iron holder further comprises a heat shield operably coupled to the handle support portion,
wherein the heat shield comprises an elevated end and a lower end, the elevated end being disposed farther away from the handle support portion than the lower end.

6. The soldering station of claim 5, wherein the heat shield comprises a metal plate formed into a half pipe.

7. The soldering station of claim 5, wherein the heat shield is disposed at an angle of 10 to 40 degrees relative to the horizontal surface supporting the soldering station.

8. The soldering station of claim 1, wherein the handle support portion comprises a collar that defines a gap, wherein the handle of the soldering iron fits through the gap, but the transition portion does not fit through the gap such that the transition portion is retained by the collar.

9. The soldering station of claim 6, wherein the metal plate has lateral sides that extend beyond the longitudinal centerline of the soldering iron when the soldering iron is disposed in the iron holder.

10. The soldering station of claim 5, wherein a length of the heat shield measured from the elevated end to the lower end exceeds a length of the soldering iron measured from the transition portion to a distal end of the tip.

11. The soldering station of claim 6, wherein the heat shield is perforated with holes.

12. The soldering station of claim 6, wherein the heat shield is removably connected to the iron holder.

13. The soldering station of claim 5, wherein the control console comprises a power source, a heat control, and an accessory holding portion.

14. The soldering station of claim 13, wherein the accessory holding portion defines a plane that is parallel to, and spaced apart from the horizontal surface supporting the soldering station by a first distance,
wherein the handle support portion is spaced apart from the horizontal surface supporting the soldering station by a second distance,
wherein the heat shield is spaced apart from the horizontal surface supporting the soldering station by a third distance, and
wherein the first distance is less than the second distance, and the second distance is less than the third distance.

15. A soldering station system comprising:
a soldering iron comprising a handle, a transition portion, a shaft portion, a tip, and a longitudinal centerline;
a control console; and
an iron holder operably coupled to the control console for supporting a soldering iron, the iron holder comprising a handle support portion and a base portion operably coupling the handle support portion to the control console,
wherein the handle support portion is oriented with respect to the base portion to define an axis,
wherein the axis forms an angle of between about 10 degrees to about 40 degrees relative to a horizontal surface supporting the soldering station, and
wherein the handle support portion is shaped to receive the soldering iron in a tip-up orientation.

16. The system of claim 15, wherein the handle support portion is shaped to correspond to a shape of the transition portion of the soldering iron.

17. The system of claim 15, wherein the axis of the handle support portion and the longitudinal centerline of the soldering iron are coaxial while the soldering iron is retained in the handle support portion.

18. The system of claim 15, wherein the handle support portion is a sole point of contact between the iron holder and the soldering iron while the soldering iron is held by the iron holder.

19. The system of claim 15, wherein the iron holder further comprises a heat shield operably coupled to the handle support portion,
wherein the heat shield comprises an elevated end and a lower end, the elevated end being disposed farther away from the handle support portion than the lower end.

20. The system of claim 19, wherein the heat shield comprises a metal plate formed into a half pipe.

21. The system of claim 19, wherein the heat shield is disposed at an angle of 10 to 40 degrees relative to the horizontal surface supporting the soldering station.

22. The system of claim 15, wherein the handle support portion comprises a collar that defines a gap, wherein the handle of the soldering iron fits through the gap, but the transition portion does not fit through the gap such that the transition portion is retained by the collar.

23. The system of claim 20, wherein the metal plate has lateral sides that extend beyond the longitudinal centerline of the soldering iron when the soldering iron is disposed in the iron holder.

24. The system of claim 19, wherein a length of the heat shield measured from the elevated end to the lower end exceeds a length of the soldering iron measured from the transition portion to a distal end of the tip.

25. The system of claim 20, wherein the heat shield is perforated with holes.

26. The system of claim 20, wherein the heat shield is removably connected to the iron holder.

27. The system of claim 19, wherein the control console comprises a power source, a heat control, and an accessory holding portion.

28. The system of claim 27, wherein the accessory holding portion defines a plane that is parallel to, and spaced apart from the horizontal surface supporting the soldering station by a first distance,
wherein the handle support portion is spaced apart from the horizontal surface supporting the soldering station by a second distance,
wherein the heat shield is spaced apart from the horizontal surface supporting the soldering station by a third distance, and
wherein the first distance is less than the second distance, and the second distance is less than the third distance.
